(19) United States
(12) Patent Application Publication
(10) Pub. No.: US 2011/0015082 A1
(43) Pub. Date: Jan. 20, 2011

(54) Systems and Methods for Evaluating Operating Conditions in a Bioreactor Using Gene Expression and Abundance Tracking

(76) Inventors: Kartik Chandran, New York, NY (US); Ran Yu, Danbury, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/679,582

(22) PCT Filed: Oct. 6, 2008
(86) PCT No.: PCT/US08/78921

§ 371 Date: Sep. 13, 2010

Related U.S. Application Data
(60) Provisional application No. 60/977,415, filed on Oct. 4, 2007.

(51) Int. Cl. C40B 30/00; C40B 60/12

(52) U.S. Cl. 506/7; 506/39

(57) ABSTRACT

Systems and methods for evaluating the operating conditions in a biological nitrogen removal reactor using gene expression and abundance tracking are disclosed. In some embodiments, the systems and methods include the following: obtaining a sample from the reactor during continuous reactor operation; expressing predetermined nitrification, denitrification, and structural genes for ammonia oxidizing bacteria contained in the sample to develop a sample genetic profile of the ammonia oxidizing bacteria; obtaining a genetic profile of a second bacteria substantially similar to the ammonia oxidizing bacteria, wherein the second bacteria was grown in a reactor having substantially optimum operating conditions; and comparing the sample genetic profile to the genetic profile of the second bacteria.

### CROSS REFERENCE TO RELATED APPLICATION(S)

This application claims the benefit of U.S. Provisional Application No. 60/977,415, filed Oct. 4, 2007, which is incorporated by reference as if disclosed herein in its entirety.

### BACKGROUND

Biological nitrogen removal (BNR) is based on nitrification and denitrification and is a conventional way of removing nitrogen from sewage and municipal wastewater. Denitrification is the second step in the nitrification-denitrification process and is a microbially facilitated process of nitrate reduction that reduces oxidized forms of nitrogen in response to the oxidation of an electron donor such as domestic wastewater or other organic matter. BNR is generally performed by heterotrophic bacteria, but can be performed by autotrophic denitrifiers. Typically, denitrifiers in BNR processes include multiple species of bacteria.

Current processes for wastewater treatment typically include BNR processes with activated sludge. Processes including activated sludge are century-old, energy intensive, aerobic processes, which require pumping oxygen into a reactor. Such processes are costly with annual costs of treating U.S. wastewater alone are $25 billion and escalating. Known activated sludge processes are typically inefficient in that they do not include bacteria communities that are specifically targeted to the organic matter contained in the wastewater stream.

Bacterial communities are typically not tailored because of an inability to target denitrifiers in activated sludge using conventional techniques. A wide fraction of activated sludge bacteria denitrify. However, conventional techniques do not reveal what specific bacteria species are most effective at consuming particular specific carbonaceous chemical oxygen demand (COD) sources, such as methanol. Conventional techniques do not allow us to directly determine the fraction of activated sludge that consumes a specific COD source of interest. As a result, bacterial communities have not been developed that target specific COD sources, which are more prevalent in a particular wastewater stream, thereby decreasing the overall efficiency of the bacteria community and therefore of the wastewater treatment system.

### SUMMARY

Methods of evaluating the operating conditions in a biological nitrogen removal reactor using gene expression and abundance tracking are disclosed. In some embodiments, the methods include the following: obtaining a sample from the reactor during continuous reactor operation; expressing predetermined nitrification, denitrification, and structural genes for ammonia oxidizing bacteria contained in the sample to develop a sample genetic profile of the ammonia oxidizing bacteria; obtaining a genetic profile of a second bacteria substantially similar to the ammonia oxidizing bacteria, wherein the second bacteria was grown in a reactor having substantially optimum operating conditions; and comparing the sample genetic profile to the genetic profile of the second bacteria.

Systems for optimizing the operating conditions in a biological nitrogen removal reactor using gene expression and abundance tracking are disclosed. In some embodiments, the systems include the following: a diagnostic module for evaluating the operating conditions in a biological nitrogen removal reactor using gene expression and abundance tracking, the diagnostic module including mechanisms for obtaining a sample from the reactor, expressing predetermined nitrification, denitrification, and structural genes for ammonia oxidizing bacteria contained in the sample to develop a sample genetic profile of the predetermined ammonia oxidizing bacteria, and comparing the sample genetic profile to a genetic profile of a second bacteria; and a corrective module for identifying deficiencies in operating parameters of the biological nitrogen removal reactor and changing the operating parameters to correct the deficiencies.

Methods of evaluating the operating conditions in a biological nitrogen removal reactor using gene expression and abundance tracking are disclosed. In some embodiments, the methods include the following: obtaining a sample from the reactor; recording operating conditions data from the reactor at a time the sample is obtained; expressing predetermined nitrification, denitrification, and structural genes for ammonia oxidizing bacteria contained in the sample to develop a sample genetic profile of the predetermined ammonia oxidizing bacteria; selecting a genetic profile of a second bacteria substantially similar to the predetermined ammonia oxidizing bacteria from a library of genetic profiles including a plurality of predetermined denitrifying bacteria; comparing the sample genetic profile to the genetic profile of the second bacteria; and comparing the operating conditions data to optimum operating conditions data related to the second bacteria.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of a system according to some embodiments of the disclosed subject matter;

FIG. 2 is a diagram of a method according to some embodiments of the disclosed subject matter;

FIG. 3 is a chart of whole community sequences from a BNR reactor;

FIG. 4 is a graph of specific bacteria activity in a BNR reactor that was determined using systems and methods according to the disclosed subject matter; and

FIG. 5 is a diagram of specific bacteria activity in a BNR reactor that was determined using systems and methods according to the disclosed subject matter.

### DETAILED DESCRIPTION

As discussed above, current BNR reactors are operated without knowledge of the active denitrification fraction taking place in the activated sludge. Presently, BNR reactors are operated without knowing whether the same bacteria degrade all COD sources or whether particular bacteria is more efficient over other bacteria at degrading a particular COD sources. Systems and methods according to the disclosed subject matter allow for the testing of BNR reactor environments and the determination of the active denitrification fraction of the activate sludge. Bacteria are analyzed on a genetic level to determine which specific bacteria are responsible for consuming specific COD sources. Systems and methods according to the disclosed subject matter provide a tool for optimizing conditions in bioreactors to sustain and promote the growth of the active denitrifying fraction.

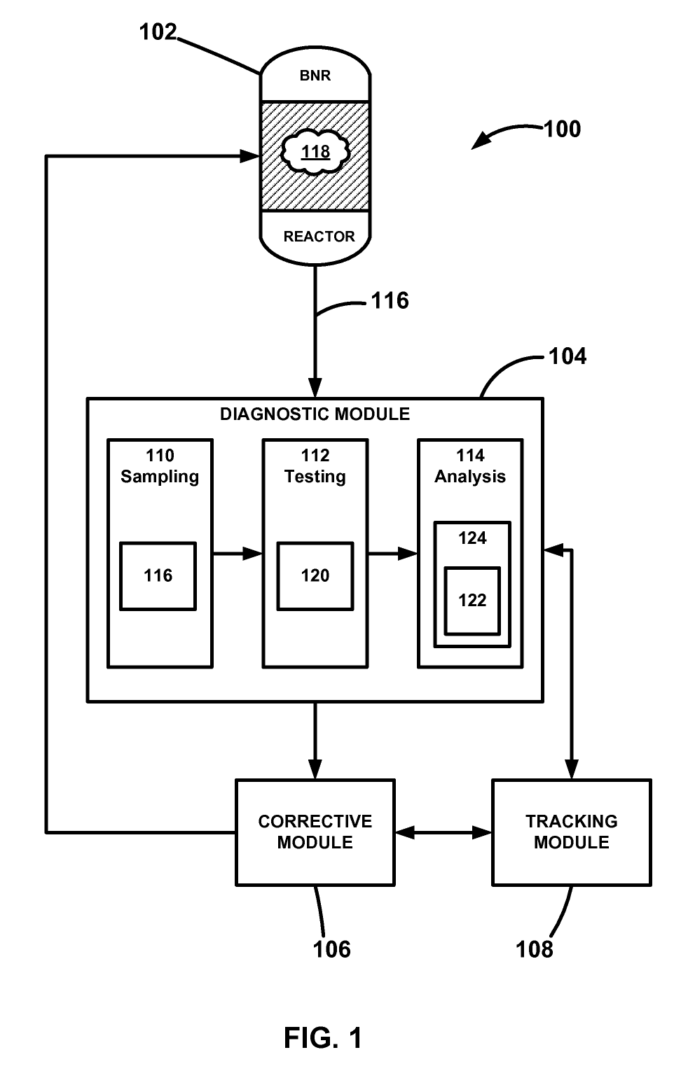

Generally, the disclosed subject matter relates to a system 100 for optimizing the operating conditions in a biological nitrogen removal reactor 102 using gene expression and abundance tracking. As represented schematically in FIG. 1, systems according to the disclosed subject matter include the following interactive modules: a diagnostic module 104; a corrective module 106; and a tracking module 108.

Diagnostic module 104 includes mechanisms for evaluating the operating conditions in a biological nitrogen removal reactor using gene expression and abundance tracking. Diagnostic module 104 includes a sampling apparatus 110, a testing apparatus 112, and an analysis apparatus 114.

Sampling apparatus 110 are used for obtaining a sample 116 from reactor 102 during batch growth of bacteria. Typically, operating conditions data from reactor 102 are recorded when sample 116 is obtained. Testing apparatus 112 are used for expressing predetermined nitrification, denitrification, and structural genes for ammonia oxidizing bacteria 118 contained in sample 116 to develop a sample genetic profile 120 of the predetermined ammonia oxidizing bacteria. In analysis apparatus 114, a genetic profile 122 for a second bacteria substantially similar to the predetermined ammonia oxidizing bacteria, but grown in a biological nitrogen removal reactor (not shown) having substantially optimum operating conditions is obtained and compared to sample genetic profile 120. Genetic profile 122 is typically obtained by selecting the genetic profile from a library 124 of genetic profiles of a plurality of predetermined nitrifying bacteria including a plurality of predetermined ammonia oxidizing bacteria grown in a biological nitrogen removal reactor and under substantially optimum operating conditions. The plurality of predetermined ammonia oxidizing bacteria included in library 124 are grown in a biological nitrogen removal reactor (not shown), are grown under substantially optimum operating conditions, and have an optimum maximum specific growth rate for specific chemical oxygen demand (COD) sources of interest. The COD sources typically include one of methanol, other organic compounds, and combinations thereof.

Corrective module 106 includes mechanisms for identifying whether deficiencies exist in operating parameters of biological nitrogen removal reactor 102 based on data from analysis apparatus 114 and comparing the operating conditions data in reactor 102 to optimum operating conditions data from the biological nitrogen removal reactor (not shown). If deficiencies are identified, corrective module 106 includes mechanisms for changing the operating parameters to correct the deficiencies.

Tracking module 108 includes mechanisms for scheduling operation of diagnostic module 104 and corrective module 106 and for storing data generated by both diagnostic module 104 and corrective module 106. For example, tracking module 108 can include a software program for scheduling sampling, testing, and corrective action on a regular basis. It is contemplated system 100 will be configured to be operated automatically and in real time. For example, certain operating parameters will be continuously evaluated by diagnostic module 104. If certain predetermined levels for those operating parameters are achieved, corrective module 106 will be automatically activated to correct the operating parameters so that they are within predetermined ranges.

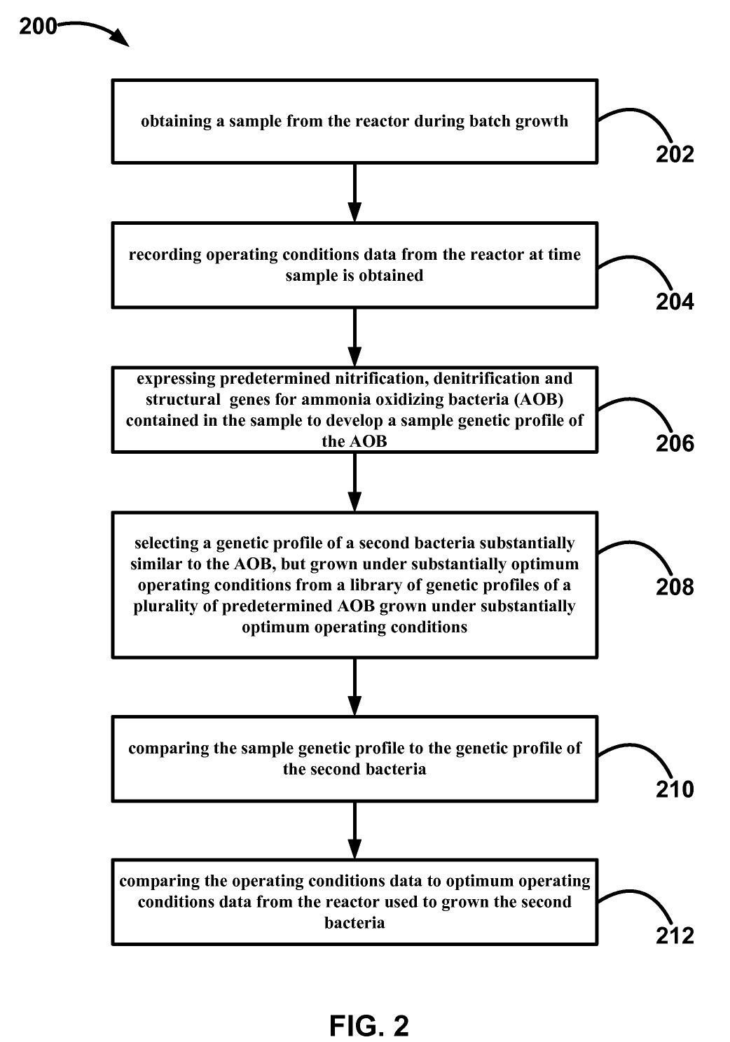

Referring now to FIG. 2, some embodiments include a method 200 of evaluating the operating conditions in a biological nitrogen removal reactor using gene expression tracking. At 202, a sample is obtained from the reactor during batch growth of the bacteria. At 204, operating conditions data is recorded from the reactor at the same time the sample is obtained. At 206, predetermined nitrification, denitrification, and structural genes are expressed for ammonia oxidizing bacteria contained in the sample to develop a sample genetic profile of the predetermined ammonia oxidizing bacteria. Typically, the predetermined nitrification genes include genes for ammonia (amoA), hydroxylamine oxidation (hao), the predetermined denitrification genes include nitrite (nirK), nitric oxide reduction (norB), and the predetermined structural genes include 16S rRNA. At 208, a genetic profile of second bacteria, which is substantially similar to the predetermined ammonia oxidizing bacteria, but grown under substantially optimum operating conditions, is selected from a library of genetic profiles of a plurality of predetermined denitrifying bacteria including ammonia oxidizing bacteria. For example, in some embodiments, the library of genetic profiles includes genetic profiles of Nitrosomonas europaea, Nitrosomonas eutropha, Nitrosospira multiformis, Nitrosomonas oligotropha, and other ammonia oxidizing bacteria sequences. The plurality of predetermined ammonia oxidizing bacteria are grown in a biological nitrogen removal reactor under substantially optimum operating conditions and have an optimum maximum specific growth rate for specific chemical oxygen demand (COD) sources of interest, such as methanol and other organic compounds. At 210, the sample genetic profile is compared to the genetic profile of second bacteria. At 212, the operating conditions data of the present reactor is compared to optimum operating conditions data from the biological nitrogen removal reactor used to grow the second bacteria.

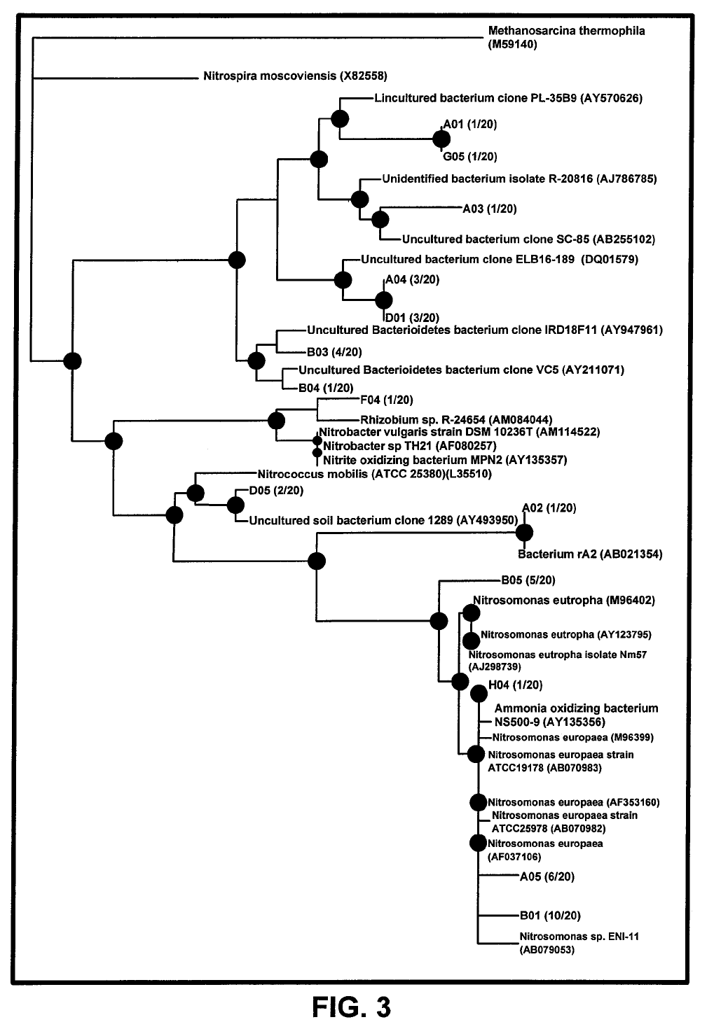

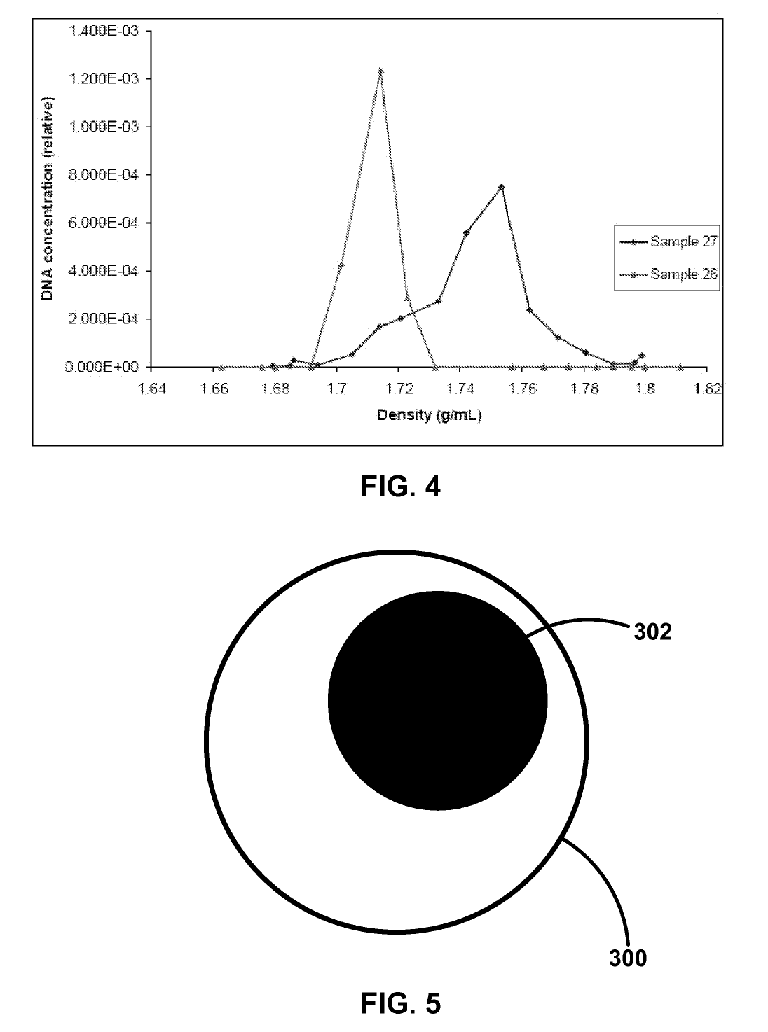

Referring now to FIGS. 3-5, systems and methods according to the disclosed subject matter were tested for performance using a BNR reactor performing denitrification using methanol as a COD source. Stable isotope probing, which includes spiking an activated sludge sample with ¹³C COD source of interest and separating ¹²C and ¹³C fractions based on weight using a centrifuge, was performed on a sample from the BNR reactor. Referring now to FIG. 3, whole community sequencing of the sample was also performed. The results of the stable isotope probing and the whole community sequencing of the sample were used to determine the methylotrophic fraction. Referring now to FIG. 4, the highest peak, which is found at a lower density corresponds to “all” organisms in the methanol fed denitrification reactor, while the second highest peak, which is found at a higher density, corresponds to “methylotrophic fraction” organisms that took up ¹³C methanol. An alternative view of the results is illustrated in FIG. 5, where a large circle 300 represents all organisms and a smaller circle 302 represents methylotrophic fraction organisms that took up ¹³C methanol.

Methods according to the disclosed subject matter provide advantages and benefits over known methods because they allow for direct determination of the activated sludge fraction that consumes any given COD source. From there, the concentrations of X_{COD1, COD2, CODn} over time can be determined. This information can be used to develop targeted bacteria communities for specific COD sources, which are more prevalent in a particular wastewater stream, thereby increasing the overall efficiency of the bacteria community and wastewater treatment system.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of evaluating the operating conditions in a biological nitrogen removal reactor using gene expression and abundance tracking, said method comprising:
obtaining a sample from said reactor during continuous reactor operation;
expressing predetermined nitrification, denitrification, and structural genes for ammonia oxidizing bacteria contained in said sample to develop a sample genetic profile of said ammonia oxidizing bacteria;
obtaining a genetic profile of a second bacteria substantially similar to said ammonia oxidizing bacteria, wherein said second bacteria was grown in a reactor having substantially optimum operating conditions; and
comparing said sample genetic profile to said genetic profile of said second bacteria.

2. The method according to claim 1, wherein obtaining said genetic profile includes selecting said genetic profile from a library of genetic profiles of a plurality of predetermined denitrifying bacteria grown in a biological nitrogen reactor and under substantially optimum operating conditions.

3. The method according to claim 2, wherein said library of genetic profiles includes genetic profiles of ammonia oxidizing bacteria.

4. The method according to claim 1, wherein said predetermined genes include genes for ammonia (amoA), hydroxylamine oxidation (hao), nitrite (nirK), and nitric oxide reduction (norB), and 16S rRNA.

5. The method according to claim 2, wherein said plurality of predetermined denitrifying bacteria are grown in a biological nitrogen removal reactor, are grown under substantially optimum operating conditions, and have an optimum maximum specific growth rate for specific chemical oxygen demand (COD) sources of interest.

6. The method according to claim 5, wherein said COD sources include methanol and other organic compounds.

7. The method according to claim 1, wherein obtaining a sample includes recording operating conditions data from said reactor.

8. The method according to claim 7, further comprising:
comparing said operating conditions data to optimum operating conditions data from said biological nitrogen removal reactor used to grow said second bacteria.

9. A system for optimizing the operating conditions in a biological nitrogen removal reactor using gene expression and abundance tracking, said system comprising:
a diagnostic module for evaluating the operating conditions in a biological nitrogen removal reactor using gene expression and abundance tracking, said diagnostic module including mechanisms for obtaining a sample from said reactor, expressing predetermined nitrification, denitrification, and structural genes for ammonia oxidizing bacteria contained in said sample to develop a sample genetic profile of said predetermined ammonia oxidizing bacteria, and comparing said sample genetic profile to a genetic profile of a second bacteria; and
a corrective module for identifying deficiencies in operating parameters of said biological nitrogen removal reactor and changing said operating parameters to correct said deficiencies.

10. The system according to claim 9, wherein comparing includes selecting said genetic profile from a library of genetic profiles of a plurality of predetermined denitrifying bacteria grown in a biological nitrogen removal reactor and under substantially optimum operating conditions.

11. The system according to claim 10, wherein said plurality of predetermined denitrifying bacteria are grown in a biological nitrogen removal reactor, are grown under substantially optimum operating conditions, and have an optimum maximum specific growth rate for specific chemical oxygen demand (COD) sources of interest.

12. The system according to claim 11, wherein said COD sources include methanol and other organic compounds.

13. The system according to claim 9, wherein obtaining a sample includes recording operating conditions data from said reactor.

14. The system according to claim 13, further comprising:
comparing said operating conditions data to optimum operating conditions data from said biological nitrogen removal reactor.

15. The system according to claim 9, wherein said modules of said system are configured to be operated automatically and in real time.

16. A method of evaluating the operating conditions in a biological nitrogen removal reactor using gene expression and abundance tracking, said method comprising:
obtaining a sample from said reactor;
recording operating conditions data from said reactor at a time said sample is obtained;
expressing predetermined nitrification, denitrification, and structural genes for ammonia oxidizing bacteria contained in said sample to develop a sample genetic profile of said predetermined ammonia oxidizing bacteria;
selecting a genetic profile of a second bacteria substantially similar to said predetermined ammonia oxidizing bacteria from a library of genetic profiles including a plurality of predetermined denitrifying bacteria;
comparing said sample genetic profile to said genetic profile of said second bacteria; and
comparing said operating conditions data to optimum operating conditions data related to said second bacteria.

17. The method according to claim 16, wherein said library of genetic profiles includes genetic profiles of ammonia oxidizing bacteria.

18. The method according to claim 16, wherein said predetermined genes include genes for ammonia (amoA), hydroxylamine oxidation (hao), nitrite (nirK), nitric oxide reduction (norB), and 16S rRNA.

19. The method according to claim 16, wherein said plurality of predetermined denitrifying bacteria are grown in a biological nitrogen removal reactor, are grown under substantially optimum operating conditions, and have an optimum maximum specific growth rate for specific chemical oxygen demand (COD) sources of interest.

20. The method according to claim 19, wherein said COD sources include methanol and other organic compounds.
